(19) United States
(12) Patent Application Publication
(10) Pub. No.: US 2013/0227216 A1
(43) Pub. Date: Aug. 29, 2013

(54) DATA STORAGE SYSTEM HAVING MULTIPLE CONTROLLER MODULES

(71) Applicant: International Business Machines Corporation, (US)

(72) Inventors: Yi-Hsin Cheng, New Taipei City (TW); Chien-Hua Huang, New Taipei City (TW); Kelvin WP Huang, Zhonghe City (TW); Nian-Guang Lee, Tainan (TW); Brent W. Yardley, Hillsboro, OR (US)

(73) Assignee: INTERNATIONAL BUSINESS MACHINES CORPORATION, Armonk, NY (US)

(21) Appl. No.: 13/770,284

(22) Filed: Feb. 19, 2013

(30) Foreign Application Priority Data
Feb. 29, 2012 (TW) 101106647

(51) Int. Cl. G06F 3/06

(52) U.S. Cl. CPC G06F 3/0689
USPC 711/114

(57) ABSTRACT

A data storage system includes a data storage module having at least a first I/O port and a second I/O port, a first controller module directly connected to the first I/O port, and a second controller module directly connected to the second I/O port. The second controller module is also in communication with the first controller module via a communication link, wherein the first and second controller modules are redundant controllers for the data storage module, and wherein, when the data storage module is controlled by the first controller module, the first controller module writes data to, or reads data from, the data storage module via a direct path to the first I/O port, and writes data to, or reads data from, the data storage module via an indirect path through the communication link and the second controller module to the second I/O port.

### CROSS-REFERENCE TO RELATED APPLICATIONS

This application is based on and claims the benefit of priority under 35 U.S.C. §119 to Taiwan Patent Application 101106647, filed on Feb. 29, 2012, the entire text of which is specifically incorporated by reference herein.

### BACKGROUND

1. Field of the Invention

The present invention relates to a data storage system, and particularly to a Redundant Array of Inexpensive Disks or Redundant Array of Independent Disks (RAID) data storage system.

2. Background of the Related Art

Existing storage arrays generally have enough redundancy, so that when there is a malfunction in a storage device within one of the storage arrays, the information contained in the malfunctioning storage device can be reconstructed from the other storage devices in that storage array. In general, for the purpose of redundancy, multiple controller modules may be used in a RAID system, and any of the multiple controller modules may be used to operate the whole RAID system.

### BRIEF SUMMARY

One embodiment of the present invention provides a data storage system, comprising a data storage module having at least a first I/O port and a second I/O port, a first controller module directly connected to the first I/O port, and a second controller module directly connected to the second I/O port. The second controller module is also in communication with the first controller module via a communication link, wherein the first controller module and the second controller module are redundant controllers for the data storage module, and wherein, when the data storage module is controlled by the first controller module rather than by the second controller module, the first controller module writes data to, or reads data from, the data storage module via a direct path to the first I/O port, and writes data to, or reads data from, the data storage module via an indirect path through the communication link and the second controller module to the second I/O port.

Another embodiment of the present invention provides a computer system, comprising a host computer, a data storage module having at least a first I/O port and a second I/O port, a first controller module directly connected to the first I/O port, and a second controller module directly connected to the second I/O port. The second controller module is also in communication with the first controller module via a communication link, wherein the first controller module and the second controller module are redundant controllers for the data storage module, and wherein, when the data storage module is controlled by the first controller module rather than by the second controller module, the first controller module writes data to, or reads data from, the data storage module via a direct path to the first I/O port, and writes data to, or reads data from, the data storage module via an indirect path through the communication link and the second controller module to the second I/O port.

### BRIEF DESCRIPTION OF THE SEVERAL VIEWS OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings.

FIG. 1 is a diagram of a computer system according to an embodiment of the present invention.

FIG. 2 is a diagram a data storage system according to an embodiment of the present invention.

### DETAILED DESCRIPTION

One embodiment of the present invention provides a data storage system, comprising a data storage module having at least a first I/O port and a second I/O port, a first controller module directly connected to the first I/O port, and a second controller module directly connected to the second I/O port. The second controller module is also in communication with the first controller module via a communication link, wherein the first controller module and the second controller module are redundant controllers for the data storage module, and wherein, when the data storage module is controlled by the first controller module rather than by the second controller module, the first controller module writes data to, or reads data from, the data storage module via a direct path to the first I/O port, and writes data to, or reads data from, the data storage module via an indirect path through the communication link and the second controller module to the second I/O port.

A data storage system of the present invention may have multiple controller modules and a data storage module (e.g. hard drive) having a plurality of I/O ports, where each I/O port is connected to a corresponding controller module. One of the plurality of controller modules, in order to perform a write or read action with a host connected thereto, may ask or authorize another “redundant” controller module to write or read data to the data storage module via the I/O port corresponding to the “redundant” data storage module. Furthermore, a controller module may write or read data to the data storage module via an I/O port of the corresponding data storage module and also via an I/O port of the data storage module corresponding to each “redundant” controller module. Accordingly, the writing and reading load may be balanced, and the speed of writing or reading data can be enhanced.

Another embodiment of the present invention provides a computer system, comprising a host computer, a data storage module having at least a first I/O port and a second I/O port, a first controller module directly connected to the first I/O port, and a second controller module directly connected to the second I/O port. The second controller module is also in communication with the first controller module via a communication link, wherein the first controller module and the second controller module are redundant controllers for the data storage module, and wherein, when the data storage module is controlled by the first controller module rather than by the second controller module, the first controller module writes data to, or reads data from, the data storage module via a direct path to the first I/O port, and writes data to, or reads data from, the data storage module via an indirect path through the communication link and the second controller module to the second I/O port.

<Computer System>

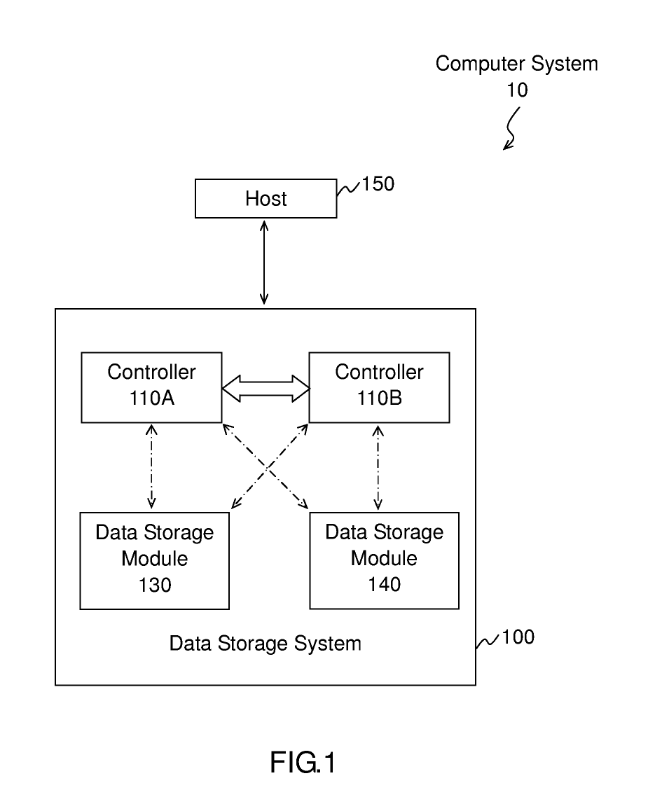

FIG. 1 shows a block diagram of a computer system 10 in in accordance with one embodiment of the present invention. The computer system 10 includes a data storage system 100 and one or more hosts 150 (only one host 150 is shown). The host 150 may be, without limitation, a server, such as IBM's System X, Blade Center, or eServer (available from International Business Machines Corporation of Armonk, N.Y.).

The host 150 and the data storage system 100 can be connected through the local bus, local area network, Internet, or other data transmission channel for data communication. In other words, the data storage system 100 can be executed as Network Attached Storage (NAS), a Storage Area Network (SAN), or Direct Attached Storage (DAS), but the present invention is not limited to this.

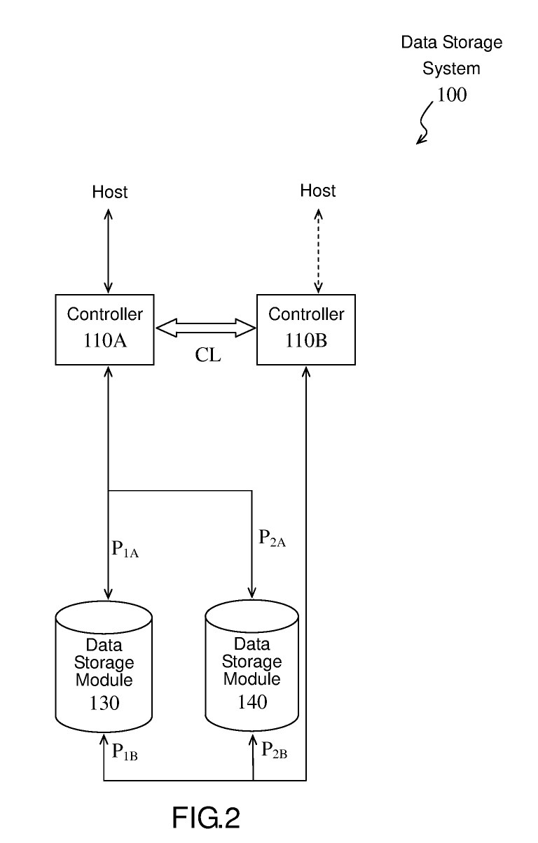

The data storage system 100 has two controller modules 110A, 110B. It should be explained that the data storage system 100 can adopt more controller modules (not shown), but the number of controller modules is not limited. More details about the controller modules 110A, 110B will be described in conjunction with the accompanying FIG. 2. The data storage system 100 also has two data storage modules 130, 140 that may be implemented as hard disks, flash memory, random access memory (RAM), CD-ROM, tape drives or other readable/writable data storage media, respectively, without limitation. In addition, the data storage modules 130, 140 are not necessarily executed as the same data storage media. In addition, it is noted first that each of the data storage modules 130, 140 may have an additional number of I/O ports, e.g. each having three, four, or more I/O ports, to communicate with additional controller modules (not shown) in the foregoing data storage system 100.

<Data Storage System>

FIG. 2 further shows the data storage system 100. In the embodiment shown in FIG. 2, the data storage modules 130, 140 are hard drives, and the data storage system 100 is implemented as a RAID system (for example, RAID 0, RAID 1, RAID 2, RAID 3, RAID 4, RAID 5, or RAID 6) through the hard drives 130, 140 (or more hard drives (not shown) in the data storage system 100). Correspondingly, in order to provide a fault tolerant environment for the data storage system 100, the controller modules 110A, 110B make use of a communication link (or referred to as “fabric”) CL for communication synchronization, and thus the two controller modules 110A, 110B can be “redundant” with respect to each other. Refer to, for example, the description of U.S. Pat. No. 6,708,285, which will not be detailed hereinafter. For more details about the basic architecture of the data storage system 100, please refer to IBM's IBM System Storage™ DS® and N series products (e.g. DS® 3000 series or DS® 3500 series). The difference of the data storage system 100 from the existing technologies will be described hereinafter.

The first and second data storage modules 130, 140 are both implemented as SAS (Serial Attached SCSI) hard drives with two I/O ports. The I/O ports of the first data storage module 130 in FIG. 2 are labeled as P_{1A} and P_{1B} respectively. The I/O ports of the second data storage module 140 are labeled as P_{2A} and P_{2B} respectively. The I/O port P_{1A} of the first data storage module 130 and the I/O port P_{2A} of the second data storage module 140 are directly connected to the controller module 110A. Similarly, the I/O port P_{1B} of the first data storage module 130 and the I/O port P_{2B} of the second data storage module 140 are directly connected to the controller module 110B. It should be noted that the so-called “direct link” or “direct path” in this text means that there are no elements capable of processing or controlling the data to be written to, or read from, the data storage module 130 or 140 on a link path (but may have one or more elements only providing data transfer or routing function). It should be noted that the number of the I/O ports for each of the data storage modules in the present invention is not limited to two in the embodiment as shown in FIG. 2, but can be three, four, or more for connecting to other controller modules.

<Write or Read>

The data storage system 100 is a data storage system with the two controller modules 110A, 110B that provide “redundancy” for each other. The write or read performed by one of the controller modules 110A, 110B can be mirrored to another controller module. Accordingly, if one of the controller modules 110A, 110B has broken down, the other of the controller modules can immediately fail-over for operation.

The controller modules 110A, 110B provide “redundancy” for each other. Therefore, in normal cases, any of the data storage modules will only be controlled by a controller module to write or read. For example, in the embodiment as shown in FIG. 2, in a normal case, the data storage modules 130, 140 are both controlled by the controller module 110A rather than by the controller module 110B. If the controller module 110A has broken down, the controller module 110B can fail-over.

However, it should be noted that the data storage system 100 can have other data storage modules (not shown). Under normal circumstances, these other data storage modules may be controlled by the controller module 110B rather than by the controller module 110A. Only if the controller module 110B has broken down, the controller module 110A would fail-over.

Particularly, when the first and second data storage modules 130, 140 are controlled by the first controller module 110A rather than by the second controller module 110B (i.e. in the case that the first controller module 110A is the “owner” of the first and second data storage modules 130, 140), the first controller module 110A writes or reads data to the first data storage module 130 and the second data storage module 140 respectively through a communication link CL, the second controller module 110B, and the I/O port P_{1B} of the first data storage module 130 and I/O port P_{2B} of the second data storage module 140.

Since the second controller module 110B is designed to provide “redundancy” to the first controller module 110A, and the first controller module 110A is used to write or read the control information (e.g. data destination address) as needed by the data storage modules 130, 140, which will be transmitted to the second controller module 110B, thereby the second controller module 110B also has the control information as needed by the data storage modules 130, 140 to write or read. Accordingly, the first controller module 110A can use the communication link CL to inform and ask the second controller module 110B to assist in writing or reading the information required by the first controller module 110A. However, it should be noted that according to this embodiment, in the case that the first controller module 110A is the “owner” of the data storage modules 130, 140, that is, the second controller module 110B assists in writing or reading the data needed by the first controller module 110A, the communication with the host 150 is still processed by the first controller module 110A or the write or read instruction transmitted by the host 150 is received by the first controller module 110A.

The above describes the case that the first controller module 110A is serving as the “owner” of the data storage modules 130, 140. Nevertheless, those skilled in the art should appreciate the case that the second controller module 110B is serving as the “owner” of the data storage modules 130, 140 (such that the first controller module 110A is providing “redundancy” for the second controller module 110B), which will not be repeated herein.

In addition, in this description, in contrast with the aforementioned “direct link” or “direct path,” the first controller module 110A authorizes the second controller module 110B to write or read data via the I/O port P_{1B} and I/O port P_{2B} (instead of the I/O port P_{1A} and I/O port P_{2A}), which is referred to as an “indirect link” or “indirect path.”

Preferably, the first controller module 110A writes or reads data to the first data storage module 130 and second data storage module 140 respectively by using both the “direct path” (via the I/O port P_{1A} and I/O port P_{2A}) and “indirect path” (via the CL and the second controller module to the I/O port P_{1B} and the I/O port P_{2B}). As the data bandwidth of a single I/O port in the data storage modules 130, 140 is limited, the foregoing method provides data transmission via two I/O ports on each data storage module, such that the transmission rate can be significantly improved. However, depending on the condition needed, the first controller module 110A can also flexibly adjust the allocation to write or read data via either a “direct path” or an “indirect path”.

Particularly, the first controller module 110A is synchronized to (or simultaneously) write or read data to the data storage module 130 or 140 via an “indirect path” and a “direct path”. In this description, synchronized or simultaneous writing or reading indicates that, in the process that the first controller module 110A handles a write or read instruction, data streams about the write or read instruction are contained on both the “indirect path” and “direct path”. For example, in the process that the first controller module 110A handles a write or read instruction, if a previous data strip written or read to the data storage module 130 is processed via an “indirect path,” the current data strip to be written or read to the data storage module 130 is processed via a “direct path,” and vice versa. However, in another embodiment, the first controller module 110A can also write or read data to the data storage module 130 or 140 sequentially according to an allocation or a predetermined order via an “indirect path” and a “direct path.” For example, whenever writing or reading two data strips to the data storage module 130 via a “direct path,” writing or reading a data strip to the data storage module 130 via an “indirect path” as well. Those skilled in the art are able to design the desired order by themselves according to actual situations, and the present invention does not want to limit it.

In a preferred embodiment where the data storage modules 130, 140 are implemented as RAID systems, to perform a write or read instruction, if the first controller module 110A has four data strips waiting to write or read a RAID system, the tasks that will be performed by the first controller module 110A are listed as follows:

(1) For the first data strip, read or write to the first data storage module 130 via the I/O port P_{1A} through a “direct path”;

(2) For the second data strip, read or write to the second data storage module 140 via the I/O port P_{2A} through a “direct path”;

(3) For the third data strip, read or write to the first data storage module 130 via the I/O port P_{1B} through an “indirect path”;

(4) For the fourth data strip, read or write to the second data storage module 140 via the I/O port P_{2B} through an “indirect path”.

In this embodiment, in the event the first controller module 110A performs a write or read instruction on the data storage module, writing or reading data strips with a “direct path” can be performed in synchronization with writing or reading data strips with an “indirect path”, by which the effect of load balance between the “direct path” and “indirect path” can be achieved.

If the data storage system 100 has more data storage modules (not shown) (i.e. a RAID 5 system needs at least three data storage modules), in order to perform a write or read instruction, preferably, the first controller module 110A first writes or reads data strips via each “direct path” to all data storage modules, and then writes or reads data strips via each “indirect path” to all data storage modules. Particularly, in this embodiment, all “direct paths” are used while all “indirect paths” are used too. The approach described above can reduce the resources required by the system spent on switching between the “direct path” and “indirect path”, but it should be noted that this approach is just illustrated as an example.

It is worthy to note that the embodiment as shown in FIG. 2 is only described with the two controller modules 110A, 110B and the two I/O ports (e.g. I/O port P_{1A} and I/O port P_{1B} or I/O port P_{2A} and I/O port P_{2B}) in each of the two data storage modules. Embodiments with more controller modules and more I/O ports can be easily appreciated by those skilled in the art, and the number of the controller modules and I/O ports of each data storage module should be consistent. However, embodiments of the present invention are not limited by the number of controller modules, data storage modules, and data paths.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention may be described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, and/or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The foregoing preferred embodiments are provided to illustrate and disclose the technical features of the present invention, and are not intended to be restrictive of the scope of the present invention. Hence, all equivalent variations or modifications made to the foregoing embodiments without departing from the spirit embodied in the disclosure of the present invention should fall within the scope of the present invention as set forth in the appended claims.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the invention.

The corresponding structures, materials, acts, and equivalents of all means or steps plus function elements in the claims below are intended to include any structure, material, or act for performing the function in combination with other claimed elements as specifically claimed. The description of the present invention has been presented for purposes of illustration and description, but it not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A data storage system, comprising:
a data storage module having at least a first I/O port and a second I/O port;
a first controller module directly connected to the first I/O port; and
a second controller module directly connected to the second I/O port and in communication with the first controller module via a communication link, wherein the first controller module and the second controller module are redundant controllers for the data storage module;
wherein, when the data storage module is controlled by the first controller module rather than by the second controller module, the first controller module writes data to, or reads data from, the data storage module via a direct path to the first I/O port, and writes data to, or reads data from, the data storage module via an indirect path through the communication link and the second controller module to the second I/O port.

2. The data storage system of claim 1, wherein the data storage module has at least one additional I/O port other than the first I/O port and the second I/O port, and wherein each additional I/O port is directly connected to a controller module other than the first controller module and the second controller module.

3. The data storage system of claim 1, wherein the first controller module is set to synchronously write data to, or read data from, the data storage module via the indirect path and the direct path.

4. The data storage system of claim 3, wherein the first controller module is set to sequentially write data strips to, or read data strips from, the data storage module via the indirect path and the direct path according to a predetermined order.

5. The data storage system of claim 3, wherein the first controller module is set to write data strips to, or read data strips from, the data storage module via the indirect path and the direct path according to a predetermined allocation.

6. The data storage system of claim 1, wherein, when the data storage module is controlled by the second controller module rather than by the first controller module, the second controller module writes data to, or reads data from, the data storage module via an indirect path through the communication link and the first controller module to the first I/O port, and writes data to, or reads data from, the data storage module via a direct path to the second I/O port.

7. The data storage system of claim 1, wherein the data storage system is a RAID system.

8. The data storage system of claim 1, wherein the data storage system is a Network Attached Storage (NAS) system, a Storage Area Network (SAN), or a Direct Attached Storage (DAS) system.

9. A computer system, comprising:
a host computer;
a data storage module having at least a first I/O port and a second I/O port;
a first controller module directly connected to the first I/O port; and
a second controller module directly connected to the second I/O port and in communication with the first controller module via a communication link, wherein the first controller module and the second controller module are redundant controllers for the data storage module;
wherein, when the data storage module is controlled by the first controller module rather than by the second controller module, the first controller module writes data to, or reads data from, the data storage module via a direct path to the first I/O port, and writes data to, or reads data from, the data storage module via an indirect path through the communication link and the second controller module to the second I/O port.

10. The computer system of claim 9, wherein the data storage module has at least one additional I/O port other than the first I/O port and the second I/O port, and wherein each additional I/O port is directly connected to a controller module other than the first controller module and the second controller module.

11. The computer system of claim 9, wherein the first controller module is set to synchronously write data to, or read data from, the data storage module via the indirect path and the direct path.

12. The computer system of claim 11, wherein the first controller module is set to sequentially write data strips to, or read data strips from, the data storage module via the indirect path and the direct path according to a predetermined order.

13. The computer system of claim 11, wherein the first controller module is set to write data strips to, or read data strips from, the data storage module via the indirect path and the direct path according to a predetermined allocation.

14. The computer system of claim 9, wherein, when the data storage module is controlled by the second controller module rather than by the first controller module, the second controller module writes data to, or reads data from, the data storage module via an indirect path through the communication link and the first controller module to the first I/O port, and writes data to, or reads data from, the data storage module via a direct path to the second I/O port.

15. The computer system of claim 9, wherein the data storage system is a RAID system.

16. The computer system of claim 9, wherein the data storage system is a Network Attached Storage (NAS) system, a Storage Area Network (SAN), or a Direct Attached Storage (DAS) system.
